(19) United States
(12) Patent Application Publication
(10) Pub. No.: US 2008/0120900 A1
(43) Pub. Date: May 29, 2008

(54) Systems and Methods for Repelling and/or Killing Pests Using Mulch

(75) Inventors: Dan O'Neal, Dallas, TX (US); Julie Gostic, McKinney, TX (US); Joshua Ingram, (US)

Correspondence Address: FULBRIGHT & JAWORSKI L.L.P, 2200 ROSS AVENUE, SUITE 2800, DALLAS, TX, 75201-2784, US

(73) Assignee: FEMO Operations, LP, Dallas, TX (US)

(21) Appl. No.: 11/947,666

(22) Filed: Nov. 29, 2007

Related U.S. Application Data
(60) Provisional application No. 60/867,731, filed on Nov. 29, 2006.

(51) Int. Cl. A01G 7/00

(52) U.S. Cl. 47/9

(57) ABSTRACT

A mulch for repelling and/or killing pests includes active ingredients. The ingredients may be substantially uniformly applied to the pieces of mulch, and the mulch pieces may be saturated, at least on their surfaces, with the active ingredients.

### CROSS-REFERENCE TO RELATED APPLICATIONS

This application claims priority from U.S. Provisional Patent Application No. 60/867,731, filed Nov. 29, 2006, the disclosure of which is hereby incorporated by reference herein.

### TECHNICAL FIELD

This description relates, in general, to repelling and/or killing pests and relates, more specifically, to doing so using mulch that contains repellant and/or insecticide.

### BACKGROUND OF THE INVENTION

One type of currently-available product that can be used to repel mosquitoes is a topical application for landscaping. In one example, insecticide or insect repellant is applied to the plants, soil, and mulch in a flowerbed by spraying exposed surfaces. While this is often effective, repeated treatments need to be used in order to consistently perform over an extended period. This is generally because the chemicals on the exposed surfaces are subject to degradation from the elements. Factors that often degrade the performance of such products include rain, watering, sun exposure, hot weather, wind, and the like. Currently, there is no product available that effectively provides pest deterrence without frequent reapplication.

### BRIEF SUMMARY OF THE INVENTION

The present invention is directed to systems and methods for repelling and/or killing pests using treated mulch. In one specific example, mulch is treated with active ingredients such that saturation, at least of the surface, of each mulch piece is achieved. In some embodiments, the saturation is substantially uniform on the outside of each piece of mulch. As a result, the pest-repellant properties of the treated mulch last longer than in mulch with topically-applied active ingredients.

Treated mulch may be produced in a variety of ways that allows for saturation and/or uniform application of active ingredients in the mulch, itself. For instance, mulch may be soaked in a solution that contains active ingredients until saturation and/or uniform application occurs. Soaking may include heat treatment and/or pressure treatment to increase the effectiveness of the soaking. Additionally, a baking step may be used to remove some of the moisture in the soaked mulch and to cause granular ingredients to adhere to the surfaces of the mulch pieces. Further, curing in bulk and/or in individual packages may also be performed to enhance the aromatic properties of the active ingredients.

Active ingredients can include any kind of pest repellant and/or insecticide, whether in liquid form or granular. Examples include garlic juice, garlic extract, granular garlic, lemon oil, lemongrass oil, rosemary oil, pyrethrins, and the like. The mulch, itself, can be any kind of mulch now known or later developed, including natural and artificial materials. In fact, some embodiments are 100% natural (or even “organic”) and contain natural mulch (e.g., wood chips) with natural active (e.g., aromatic essential oils that repel pests) and inactive (e.g., water) ingredients.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is an illustration of an exemplary treated mulch adapted according to one embodiment of the invention; and

FIG. 2 is an illustration of an exemplary method adapted according to one embodiment of the invention for making and using a treated mulch, such as the treated mulch of FIG. 1.

### DETAILED DESCRIPTION OF THE INVENTION

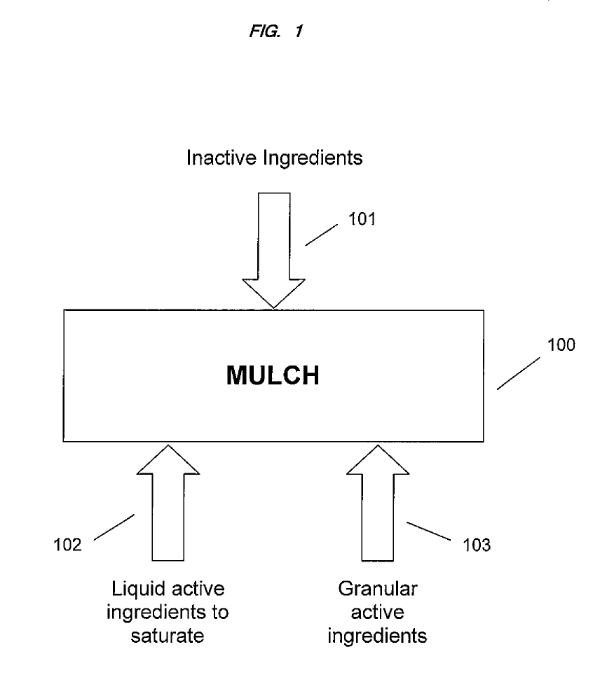

According to one embodiment of the invention, treated mulch can be used to repel and/or kill a variety of pests, including mosquitoes, flies, fleas, mites, and the like. FIG. 1 is an illustration of exemplary treated mulch 100 adapted according to one embodiment of the invention. Mulch 100, itself, can be made of natural materials, e.g., wood, natural fibers, and the like. Alternatively or additionally, mulch 100 can be made of artificial materials, e.g., plastic, rubber, artificial fibers, and the like. In one specific embodiment, mulch 100 includes one or more types of wood material, such as cedar wood, pine wood, and/or other hard or soft woods.

A variety of treatments are possible to give mulch 100 anti-pest qualities. One technique is to treat the mulch pieces with pest-repelling active ingredients 102 and/or 103. An example of liquid active ingredients 102 is natural oils that act as an aromatic repellant. For instance, essential oils, such as from lemongrass, lemons, peppermint, rosemary, and garlic may be used. In one embodiment, an impregnating solution is made of a mixture of those oils with lemongrass oil accounting for about 1%-5%, lemon oil at about 1%-5%, peppermint at about 1%-5%, rosemary at about 1%-5%, and garlic at about 40% or more. The remainder may include natural food byproducts and inactive ingredients 101, such as water.

Additional active ingredients that can be employed in some embodiments include, but are not limited to:

castor oil (U.S.P or equivalent);

cedar oil;

cinnamon and cinnamon oil;

citric acid;

citronella and citronella oil;

cloves and clove oil;

corn gluten meal;

corn oil;

cottonseed oil;

dried blood;

D-limonene

eugenol

geraniol;

geranium oil;

lambda-cyhalothrin;

lauryl sulfate;

linseed oil;

malic acid;

mint and mint oil;

peppermint and peppermint oil;

permethrin

2-phenethyl propionate (2-phenylethyl propionate)

potassium sorbate;

putrescent whole egg solids;

pyrethrin;

phyrethroids;

sesame (includes ground sesame plat) and sesame oil;

sodium chloride (common salt);

sodium lauryl sulfate;

soybean oil;

thyme and thyme oil;

white pepper; and

zinc metal strips (including zinc metal and impurities).

Of the various ingredients mentioned above, garlic and lemon tend to show the highest efficacy in repelling mosquitoes. Further, combinations that include one or more of cedar oil, cinnamon oil, citronella oil, lambda-cyhalothrin, rosemary oil, lemongrass oil, peppermint oil, pyrethrins, pyrethroids, and D-Limonene also tend to show high efficacy in repelling and/or killing mosquitoes. However, ratios may be changed and/or other ingredients added to optimize the treated mulch for pest type, geographic area, and other factors.

Some of the ingredients may be added as granular active ingredients 103. For instance, some or all of the garlic may be granular. An advantage of using granular ingredients 103 is that they generally have a longer life span than liquid ingredients since not all of the volume of a granule is adjacent to air or otherwise exposed to the elements. Disadvantages often include less intensity for the same weight of ingredient when compared to liquids, and in-package settling that results in uneven distribution of granules within the mulch. Techniques for applying liquids 102 and granules 103 are discussed more fully herein below.

In addition to repellant essential oils, some embodiments may also include natural or artificial pesticides, such as pyrethrins. One example includes an organic treated mulch, wherein the mulch, itself, is wood, and the rest of the active 102, 103 and inactive 101 ingredients are organic or otherwise natural.

In various embodiments, active ingredients 102 and 103 are distributed evenly. Further, in some embodiments, the mulch pieces (or at least the surfaces thereof) are saturated with the liquid active ingredients such that the active ingredients have a long lifespan, slowly being drawn out of the individual mulch pieces over time. Of course, life span will differ based on a number of factors, e.g., rainfall, watering, sun exposure, temperature, and the like. However, all factors being equal, some amount of even surface saturation or uniform impregnation will generally provide better performance for a longer period of time than will mulches that have been topically treated after being laid down (as used herein, “uniform impregnation does not require that the impregnation be exactly uniform, only that entire surface be impregnated to some degree). In one particular example using essential oils, the amount of active ingredients 102 and 103 that is impregnated in mulch 100 is about one-fifth of a pound to one pound for a twenty-five pound bag (approximately 2 cubic feet) of cedar mulch. Active ingredient amounts may be increased or decreased for a variety of factors, such as cost, effectiveness, duration, perceived pleasantness of look and/or odor, and the like.

Various techniques for making treated mulch 100 according to embodiments of the invention are possible. One specific example includes a combination of methods. One of the methods includes making or acquiring at least some of the active ingredients in liquid form. The mulch is then soaked in one or more of the liquid ingredients. Depending on which types of material (e.g., woods) are included in the mulch, soaking might require different lengths of time. For example, drier and more porous materials generally use less soaking time. Also, some types of wood absorb liquids more quickly or more slowly than others. A further technique for soaking includes stirring the mix to enhance uniformity of impregnation. Another method that may be included in some embodiments is heating the liquids, especially the essential oils, to a relatively high temperature to optimize the soaking. Additionally, a pressurizing process can be used to further optimize absorption into the mulch. Yet another method that can be used is a baking process to remove excess moisture. A baking process may further be used to cause granular ingredients to adhere to the individual pieces of mulch. An example product that may be produced from one or more of the methods is a thoroughly soaked, pressurized, and heat-sealed mulch with a granular residual baked on the outside to lengthen the effectiveness of the product over time.

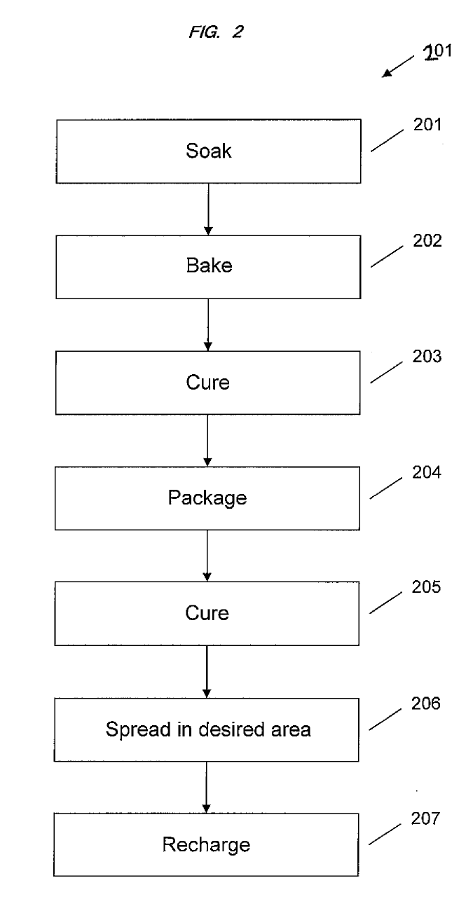

FIG. 2 is an illustration of exemplary method 200 adapted according to one embodiment of the invention for making and using a treated mulch, such as treated mulch 100 (FIG. 1). Method 200 includes soaking 201 and baking 202, as discussed above. Mulch production often includes a dyeing step wherein the mulch is exposed to dye, e.g., by soaking. In some embodiments, step 201 can be performed before, during, or after a dyeing step. In addition to the techniques described above, some embodiments include adding one or more “pleasant” aromas during soaking 210 to make the resulting mulch more pleasing for humans. For example, an aroma can be added that complements or otherwise ameliorates the pungency of garlic. A mixture of garlic, lemon, and rosemary may be perceived by some humans as a pleasant cooking-type smell and may not benefit appreciably from other aromatics, at least with regard to human perception. If appropriate, additional aromatics can be added at any time during manufacture, packaging 204, or spreading 206.

Another technique that may be used for producing mulch in some embodiments is an aging or curing process (e.g., steps 203 and/or 205) that includes letting treated mulch spend time in bulk (as in 203) or in individual packages (as in 205). Aging or curing 203 and 205 may allow the active ingredients to mature, mix, or even strengthen in intensity to increase the effectiveness of the mulch product. It should be noted that various embodiments may add, omit, or rearrange the steps mentioned above. For instance, one embodiment includes soaking 201 at a high temperature and baking 202 and omits low-temperature soaking and high-pressure soaking. Various embodiments can use any technique now known or later developed to uniformly impregnate at least the surface of mulch with an active ingredient and/or to apply a granular ingredient. While steps 201-205 are generally performed by a maker and/or seller of the treated mulch, step 206 is generally performed by a consumer of the mulch. For instance, in step 206, a consumer may spread the mulch in a flowerbed, in a garden, around a tree, or the like.

Various embodiments may include optimizing the treated mulch for geographic areas by changing ratios of active ingredients, adding or omitting some active ingredients, and selecting mulch types. For example, different species of pests, especially mosquitoes, inhabit different areas of the world, and different species are often differently affected by active ingredients. Further, people in different areas of the world sometimes prefer different types of wood mulch. Thus, the types of mulch and active ingredients can be selected based upon the geographic area that the mulch is expected to be used in. Further, different consumers may prefer different types of mulch or different scents for purely personal or aesthetic reasons, and various embodiments of the invention include catering to those tastes by changing the type of mulch and the active and inactive ingredients therein. A variety of combination of mulch types, active ingredients, concentrations of active ingredients, and ratios of active ingredients can be used in embodiments of the invention as long as pest repelling and/or killing properties are also present in the mulch.

Even though various embodiments of the invention offer more performance for a longer period of time compared to other solutions, it is possible that the effectiveness of the treated mulch may wane before the user is ready to replace it. For example, if the mulch is still visually pleasing to the user, the user may desire not to replace it. Accordingly, it is possible to provide a recharge kit to the user to replace some of the effectiveness of the mulch. One or more recharge kits may include a concentrated solution of active ingredients to be applied to the mulch. In one example, the recharge kit includes a container that the user attaches to a garden hose. The container holds a concentrated solution of active ingredients, and the hose pressure causes the solution and some water to spray out. Thus, the active ingredients can be applied by spraying or other methods in step 207.

Embodiments of the invention may include one or more advantages over prior solutions. For instance, some embodiments add functionality to a product that many people already buy. In other words, some embodiments fill two roles because they provide beautification of the home in the flower beds and provide all the aesthetically pleasing attributes of mulch, while at the same time reducing pests. Homeowners and landscapers often purchase mulch for beautification and purchase pest-related products in addition to the mulch. Thus, embodiments of the invention may allow some consumers to reduce purchases and even save money. In fact, some embodiments may include a pre-packaged and ready-to-spread mulch that is readily available to consumers from garden/landscape suppliers. Further, as mentioned above, impregnating mulch with active ingredients, especially when it is done uniformly and there is some amount of saturation, can provide a longer effective life span for the product when compared to mulches that merely have a topical application of an active ingredient.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A landscaping item for reducing pests, said item comprising:
mulch, including a plurality of individual mulch pieces;
one or more active ingredients including a garlic component, wherein said mulch is uniformly impregnated with at least some of said active ingredients.

2. The landscaping item of claim 1 further comprising:
granular active ingredients adhered to surfaces of said individual mulch pieces.

3. The landscaping item of claim 1 further comprising:
packaging, wherein said mulch and said active ingredients are enclosed by said packaging.

4. The landscaping item of claim 1 further comprising:
pyrethrin.

5. The landscaping product of claim 1, wherein said active ingredients include two or more of the following:
garlic oil;
garlic juice;
garlic extract;
rosemary oil;
lemongrass oil;
lemon oil; and
peppermint oil.

6. The landscaping product of claim 1 wherein said mulch and said active ingredients contain only organic components.

7. A method for making mulch, said method comprising:
impregnating said mulch with one or more active ingredients uniformly, wherein said active ingredients include one or more of the following:
garlic;
rosemary oil;
lemongrass oil:
lemon oil; and
peppermint oil;
cinnamon oil;
Lambda-cyhalothrin;
Pyrethrins;
D-Limonene; and
packaging said impregnated mulch.

8. The method of claim 7, wherein said impregnating includes one or more of:
soaking said mulch with at least one of said active ingredients;
baking said mulch with at least one of said active ingredients;
pressure treating said mulch with at least one of said active ingredients.

9. The method of claim 7 wherein said impregnating further comprises:
curing said mulch in bulk; and
curing said mulch in its packaging.

10. The method of claim 7 wherein said active ingredients further comprise pyrethrin.

11. The method of claim 7 further comprising:
treating said mulch to cause one or more granular active ingredients to adhere to individual pieces of said mulch.

12. The method of claim 11 wherein said one or more granular active ingredients include garlic granules, and wherein said treating said mulch comprises:
baking said mulch and said garlic granules.

13. The method of claim 7 wherein said mulch and said active ingredients contain only natural components.

14. The method of claim 7 wherein said mulch and said active ingredients contain only organic components.

15. A method for landscaping, said method comprising:
purchasing a package of mulch, said mulch being natural and pre-treated with one or more aromatic mosquito-repelling active ingredients such that the active ingredients impregnate individual mulch pieces on the entireties of their respective surfaces; said one or more active ingredients being all-natural and including at least garlic; and
spreading said mulch onto an outdoor soil substrate.

16. The method of claim 15 wherein said active ingredients include one or more of the following:
garlic oil;
garlic juice;
garlic extract;
rosemary oil;
lemongrass oil;
lemon oil; and
peppermint oil.

17. The method of claim 15 wherein said mulch also includes garlic granules distributed therein.

18. The method of claim 15 wherein said mulch also includes pyrethrin.

19. The method of claim 15 wherein said mulch and said active ingredients contain only organic components.

20. A landscaping item for reducing pests, said item comprising:
mulch, including a plurality of individual mulch pieces;
one or more active ingredients including a lemon component, wherein said mulch is uniformly impregnated with at least some of said active ingredients.

21. A landscaping item for reducing pests, said item comprising:
mulch, including a plurality of individual mulch pieces;
one or more active ingredients including a rosemary component, wherein said mulch is uniformly impregnated with at least some of said active ingredients.

22. A landscaping item for reducing pests, said item comprising:
mulch, including a plurality of individual mulch pieces;
one or more active ingredients, wherein said mulch is uniformly impregnated with at least some of said active ingredients, and wherein said active ingredients include one or more of the following:
citronella;
peppermint;
lemongrass oil; and
peppermint oil.

23. A landscaping item for reducing pests, said item comprising:
mulch, including a plurality of individual mulch pieces;
one or more active ingredients, wherein said mulch is uniformly impregnated with at least some of said active ingredients, and wherein said active ingredients include one or more of the following:
D-Limonene;
Lambda-cyhalothrin;
lemongrass oil; and
peppermint oil.
